(19) United States
(12) Patent Application Publication
(10) Pub. No.: US 2016/0265274 A1
(43) Pub. Date: Sep. 15, 2016

(54) Flexible Window Screen

(71) Applicant: James Rapp, Orange, TX (US)

(72) Inventor: James Rapp, Orange, TX (US)

(21) Appl. No.: 15/019,679

(22) Filed: Feb. 9, 2016

Related U.S. Application Data
(60) Provisional application No. 62/133,053, filed on Mar. 13, 2015.

(51) Int. Cl. E06B 9/52

(52) U.S. Cl. CPC E06B 9/52; E06B 2009/524

(57) ABSTRACT

Disclosed are apparatuses and methods for use of a mesh screen having a perimeter, an elastomeric material, and a flexible frame that surrounds elastomeric material and is attached to the mesh screen at or substantially proximate to the perimeter, wherein the flexible frame surrounds an entirety of the perimeter. In another embodiment, the flexible frame constitutes connected portions of flexible frame having elastomeric material(s) and portions of flexible frame not having elastomeric material(s). Example use may include pushing the apparatus into a window seal of a window opening to prevent macroscopic materials, such as particulates and insets, from ingress or egress into an otherwise closed system, such as the interior of an automobile.

### REFERENCE TO RELATED APPLICATION

The present application claims priority to U.S. provisional patent application Ser. No. 62/133,053 filed Mar. 13, 2015, which is hereby incorporated by reference in its entirety.

### FIELD

The disclosure generally relates to apparatuses and methods regarding a flexible screen for optional placement in a window frame.

### BACKGROUND

An open window permits a homeowner, automobile driver, and so forth to take advantage of outside temperatures and breezes to cool and freshen the interior of the home, automobile, etc. To avert particulates, insects, such as misquotes as well as other bugs, screens are commonplace in some windows. Density of a screen's mesh is often determinative of which particulates, insects, or other matters are barricaded from entry into an otherwise closed system. That is, as mesh density increases, then so does the likelihood of entry of macroscopic matter into the otherwise closed system.

A typical window screen has a rigid or semi-rigid frame having a stretched mesh panel located between and attached to the frame members of the screen frame. The materials constituting the screen frames, themselves, may include a variety of materials, such as aluminum, or wood, fiberglass, plastic, or other materials. The mesh panels may be made from metal wire, such as aluminum, or fiberglass, synthetic fiber mesh, plastic or other materials.

Moving on, framed window screens may be placed and retained in a complementary window opening. Means for retaining may include, for example, pressure-sensitive clip(s), buckle(s), snap(s), button(s), latch(es), lock(s), friction, grooved-placement that provide a small lip around at least a portion of the exterior of the framed window screen, or other retaining means.

Rigid or semi-rigid framed window screens, however, are a problem for window openings in automobiles. For one, installation of rigid or semi-rigid frames is not possible in most, if not all, window openings in automobiles. For another, removal and storage of rigid or semi-rigid framed window screen are difficult, especially while in transit. As further discussed, this disclosure permits easy installation, removal and storage without requiring magnetic, adhesive or other connecting material or having to at least partially close the window to securely place the window screen.

### SUMMARY

In one embodiment, disclosed is a an apparatus including a mesh screen having a perimeter, an elastomeric material, and a flexible frame that surrounds the elastomeric material and is attached to the mesh screen at or substantially proximate to the perimeter, wherein the flexible frame surrounds at least a portion of an entirety of the perimeter. In other example embodiments, the flexible frame comprises at least a first portion of material without having elastomeric material, i.e., the material does not surround or otherwise enclose elastomeric material, and is attached to the mesh screen at or substantially proximate to the perimeter such that together, i.e., the flexible frame surrounding the elastomeric material and the flexible frame having the material, entirely surround the mesh screen at or substantially proximate to the perimeter.

In another embodiment, disclosed is a method. The method may include enclosing, with at least a first portion of a flexible frame, one or more elastomeric materials to produce at least a first enclosed portion of the flexible frame. Further, the method may include attaching the first enclosed portion to a mesh screen at or substantially proximate to a first perimeter portion of a perimeter of the mesh screen. Further still, the method may include enclosing one or more additional portions of the flexible frame with the one or more elastomeric material to produce one or more additional enclosed portions of the flexible frame. And, yet further, the method may include attaching the one or more additional enclosed portions to the mesh screen at or substantially proximate to one or more additional perimeter portions of the perimeter of the mesh screen so that an entirety of the perimeter surrounded by the flexible frame having the first portions and the one or more additional portions.

In another embodiment, disclosed is another method. The method may include pushing a flexible window screen into at least a portion of a window seal of a window opening, and retaining, by the window seal, at least a portion of the flexible window screen. Further, the method may include fully opening the window opening. Further still, the method may include hanging down of the flexible window screen that is not in the window seal. Here, for example, hanging down portion(s) may include material on one or more portions, e.g., a bottom portion, of the flexible window screen, whereby the material does not enclose one or more elastomeric materials, but still forms part of the flexible frame at or substantially proximate to the perimeter of the mesh screen framed by the flexible frame also including surrounded elastomeric material(s). Additionally and alternatively, the hanging down portion(s) may include excess portion(s) of the flexible frame, regardless whether the flexible frame encloses elastomeric material(s) or not, whereby, if not, then such portion(s) of the flexible frame is merely a material without the elastomeric material; these excess portion(s) hang down because they are not or cannot be pushed into the window seal. Using the bottom portion as an example, the bottom portion may just hang down over one or both sides of the bottom portion of a window opening.

### BRIEF DESCRIPTION OF THE DRAWINGS

So that the manner in which the above recited features, advantages and objects of this disclosure are attained and may be understood in detail, a more particular description, briefly summarized above, may be had by reference to the embodiments thereof which are illustrated in the appended drawings.

It is to be noted, however, that the appended drawings illustrate only typical embodiments of this disclosure and are therefore not to be considered limiting in scope, for the disclosure may admit to other equally effective embodiments.

FIG. 1A depicts an example embodiment of the disclosed flexible window screen.

FIG. 1B depicts an example embodiment of the disclosed flexible window screen placed in an automobile window opening.

FIG. 1C depicts an example embodiment of the disclosed flexible window screen.

### DETAILED DESCRIPTION

Below, directional terms, such as “above,” “below,” “upper,” “lower,” “front,” “back,” “top,” “bottom,” etc., are used for convenience in referring to the accompanying drawings. In general, “above,” “upper,” “upward,” “top,” and similar terms refer to a direction away the earth's surface, and “below,” “lower,” “downward,” “bottom,” and similar terms refer to a direction toward the earth's surface, but is meant for illustrative purposes only, and the terms are not meant to limit the disclosure.

This disclosure relates to methods and apparatuses for a flexible window screen and optional placement thereof within a window opening, such as by pushing into the window seal of fully opened window (i.e., completely down) in an automobile.

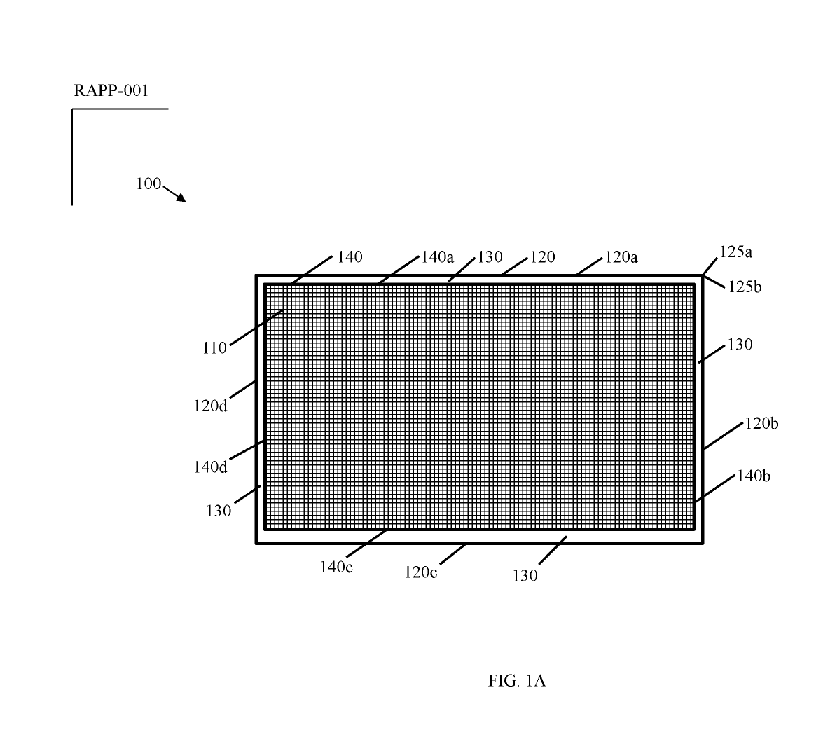

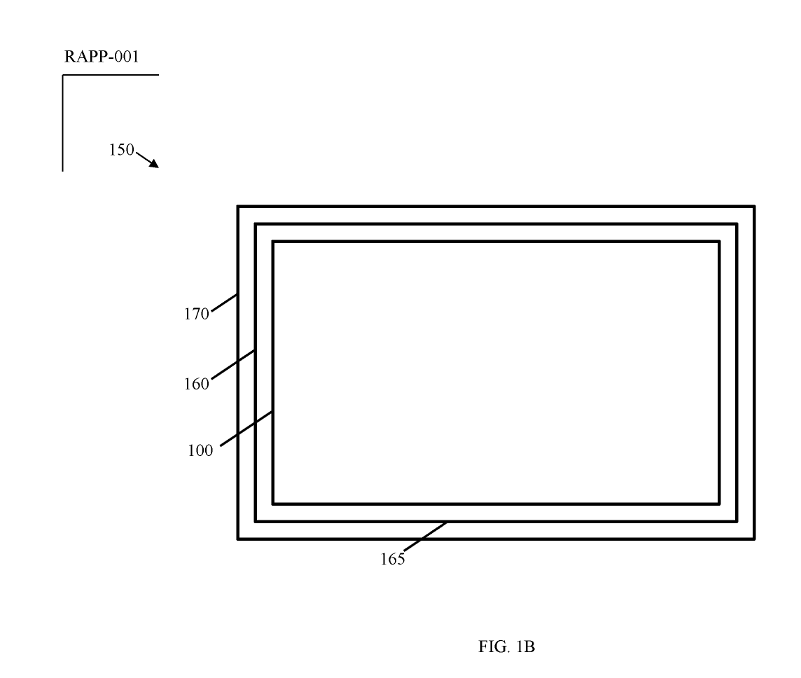

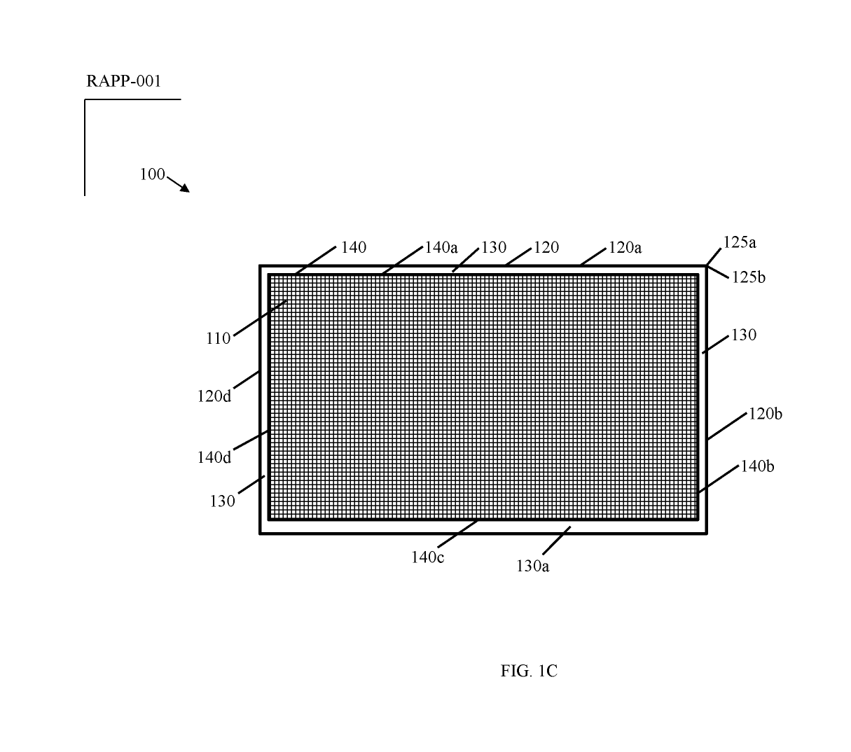

Turning to FIG. 1A, depicted is an apparatus 100 called a “flexible window screen.” The flexible window screen 100 includes a mesh screen 110. The mesh screen 110 may be made of any suitable screening material for a screen from ingress or egress of macroscopic materials, e.g., particulates, insects, and other airborne materials, while still permitting air to circulate. Suitable materials may for the mesh screen 110 include metal, non-metal, fibrous, organic, inorganic, plastic, other synthetic materials, or combinations thereof arranged in a hash pattern or other pattern so as to provide effective screening under the particular circumstances.

Attached to the mesh screen 110 is a flexible frame 130 surrounding one or more elastomeric materials 120 therein. The flexible frame 130 is made from one or more enclosing materials that are fabric, plastic, other materials, or combinations thereof for the elastomeric material 120. Suitable materials for the elastomeric material 120 may include any material that imparts flexibility. Preferably, such suitable materials are also robust. Non-limiting examples of suitable materials include one or more materials that are plastic, rubber, natural, synthetic, such as nylon, or combinations thereof, wherein any of the foregoing may be thermoset, thermoplastic, saturated, unsaturated, or combinations thereof. The elastomeric material 120, itself, may be in the shape of a cord, band, rope, strip, or otherwise.

The flexible frame 130 attaches to the mesh screen 110 at or substantially proximate to the perimeter 140 of the mesh screen 110. The enclosing material 130 may surround an elastomeric material 120 and may attach to the mesh screen 110 by sewing, adhering (i.e., whether cold, heat, and/or pressure induced), buttoning, snapping, otherwise affixing, or combinations thereof. Similarly, the enclosing by the enclosing material 130 may occur also by sewing, adhering, buttoning, snapping, otherwise affixing, or combinations thereof. Accordingly, enclosing and attaching may be a one or multi-step process. That is, one may insert the elastomeric material 120 into an enclosing material 130, such as a strip of cotton, and sew the strip of cotton so as to simultaneously enclose the elastomeric material 120 and attach the enclosed 130 elastomeric material 120 at or substantially proximate to the perimeter 140 of the mesh screen 110.

In another example embodiment, one may insert the elastomeric material(s) 120 into a flexible frame 130, such as a strip of polyester fabric to enclose the elastomeric material 120, and then perform a second step of sewing and/or adhering the flexibly framed 130 elastomeric material 120 at or substantially proximate to the perimeter 140 of the mesh screen 110. The depicted example embodiment at FIG. 1A may require four enclosed portions 120a, 120b, 120c, 120d of flexible frame 130 having the elastomeric material 120 inserted therein, whereby different ends 125a, 125b of two portions 120a, 120b are attached by sewing, adhering, buttoning, snapping, otherwise affixing, or combinations thereof so as to result in a flexible window screen 100 having a flexible frame 130 with enclosed elastomeric material 120 that surrounds the entirety of the perimeter 140. Stated more generally, the method may include enclosing, with at least a first portion of a flexible frame 130, one or more elastomeric materials 120 to produce at least a first enclosed portion of the flexible frame 130. The first enclosed portion 120a may be attached to a mesh screen 110 at or substantially proximate to a first perimeter portion 140a of a perimeter 140 of the mesh screen 110. For further construction of the apparatus 100, it may be necessary to enclose one or more additional portions 120b, 120c, 120d of the flexible frame 130 with the one or more elastomeric materials 120 to produce one or more additional enclosed portions 120b, 120c, 120d of the flexible frame 130. The one or more additional enclosed portions 120b, 120c, 120d attach to the mesh screen 110 at or substantially proximate to one or more additional perimeter portions 140b, 140c, 140d of the perimeter 140 of the mesh screen 110 so that an entirety of the perimeter 110 surrounded by the flexible frame 130 has the first portions 120a and the one or more additional portions 120b, 120c, 120d.

Turning now to FIG. 1B, depicted is a block representation of the flexible window screen 100 placed in a window seal 160 of a window opening 170. In an automobile context, the window seal 160 is typically composed of rubber that is grooved for ascent and descent of a window in the window opening 170. Placement of the flexible window screen 100 into a window seal 160 may occur by pushing the enclosed 130 elastomeric material 120 into the window seal 160 when the window is in a fully down position such that the window opening 170 is fully opened. Having pushed the flexible window screen 100 into the window seal 160, the flexible window screen 100 is retained within the window seal 160 by its 160 rubber seals pushing back on the pushed-in portions of the flexible window screen 100.

Although FIGS. 1A and 1B depict the flexible window screen 100 as rectangular, any other shape is possible, such as triangular, trapezoidal, rhomboidal, quadrilateral, hexagonal, circular, elliptical, and so forth. Stated otherwise, the flexible window screen 100 may have any height, width and shape so as to fit a window opening 170. For example, a flexible window screen 100 for use on a window opening 170 on a Cadillac® Escalade would have to be longer and wider than a flexible window screen 100 for use on a window opening 170 on a Fiat® 500. If a rectangular-shaped flexible window screen 100 were used for either automobile window opening 170, then flexible window screen 100 that cannot be and/or is not pushed into the window seal 160 to create a completely screened window opening 170 would just hang down. If any portions do hang down, then this may be the result of excess flexible window screen 100 that cannot or is not pushed into the window seal 160 and/or one or more portions of the flexible window screen 100 that hang down over, for example, the bottom portion 165 of a window seal 100. For example, for portion(s) hanging down over the bottom portion 165, such portion(s) may hang down on the inside, the outside, or combinations thereof of a car's window opening 170.

In alternative embodiments to one or more standard sizes, a custom-sized flexible window screen 100 for a particular automobile's window opening 170 may be made so that no excess flexible window screen 100 hangs down because it 100 cannot fit into a window seal 160 despite the entire window opening 170 being closed by the non-excess flexible window screen 100.

Whether all or one or more portions of the flexible window screen 100 are pushed inside a window seal 160, FIG. 1C depicts another example embodiment of the flexible window screen 100. Instead of the flexible frame 130 surrounding one or more elastomeric portions 120a, 120b, 120c, 120d attached at or substantially proximate to an entirety of the perimeter 140, the flexible window screen 100 in FIG. 1C has at least one portion, i.e., a bottom portion in this case, that is a material 130a without one or more elastomeric materials 120. That is, the material 130a may be fabric, plastic, other materials, or combinations thereof without enclosing one or more elastomeric materials 120. Manufacture and use of the example embodiment depicted at FIG. 1C may occur as disclosed herein with other embodiments. With specific reference to FIG. 1C, what is depicted is a flexible frame 130 having three of its four sides surrounding three portions of elastomeric material(s) 120a, 120b, 120d, and another portion of flexible frame 130a without any elastomeric material(s), such that the flexible frame 130, 130a surrounds at least a portion, and, in this case, an entirety of the perimeter 140 of the mesh screen 110 of the flexible window screen 100. Stated otherwise, the flexible frame 130a in this case constitutes one or more portions of material(s) that also take part in framing the mesh screen 110.

The flexible window screen 100 allows for easy installation, removal, and foldable storage—even during transit—and does not damage or require adaptations to the automobile. Although the foregoing disclosure discusses window openings 170 in relation to automobiles, methods of use for the disclosed apparatus 100 apply to any window opening 170 permitting retention by seals or other fittings within a window opening 170.

While the foregoing is directed to example embodiments of the disclosed invention, other and further embodiments may be devised without departing from the basic scope thereof, wherein the scope of the disclosed apparatuses, systems and methods are determined by one or more claims.

What is claimed is:

1. An apparatus comprising:
a mesh screen having a perimeter;
an elastomeric material; and
a flexible frame that surrounds the elastomeric material and is attached to the mesh screen at or substantially proximate to the perimeter,
wherein the flexible frame surrounds at least a portion of an entirety of the perimeter.

2. The apparatus of claim 1, wherein the mesh screen is a material comprising metal, non-metal, fibrous, organic, inorganic, plastic, synthetic materials, or combinations thereof.

3. The apparatus of claim 1, wherein the at least a portion of an entirety is the entirety of the perimeter.

4. The apparatus of claim 1, wherein the mesh screen has a hash pattern with a density of screening material sufficient to prevent ingress or egress of mosquitos.

5. The apparatus of claim 1, wherein the elastomeric material comprises one or more materials that are rubber, natural, synthetic, or combinations thereof.

6. The apparatus of claim 1, wherein the elastomeric material comprises one or more materials that are thermoset, thermoplastic, saturated, unsaturated, or combinations thereof.

7. The apparatus of claim 1, wherein the elastomeric material comprises a cord or a band.

8. The apparatus of claim 1, wherein the flexible frame comprises one or more materials that are fabric, plastic, or combinations thereof.

9. The apparatus of claim 1, wherein the flexible frame is attached to the mesh screen by sewing, adhering, buttoning, snapping, or combinations thereof.

10. The apparatus of claim 1, wherein the flexible frame further comprises at least a first portion of material without the elastomeric material and is attached to the mesh screen at or substantially proximate to the perimeter.

11. A method comprising:
enclosing, with at least a first portion of a flexible frame, one or more elastomeric materials to produce at least a first enclosed portion of the flexible frame; and
attaching the at least a first enclosed portion to a mesh screen at or substantially proximate to a first perimeter portion of a perimeter of the mesh screen,
whereby, the method produces a flexible window screen.

12. The method of claim 10, further comprising attaching at least a first portion of material without the one or more elastomeric materials to a mesh screen at or substantially proximate to a first perimeter portion of a perimeter of the mesh screen, wherein the flexible frame has the at least a first enclosed portion and the at least a first portion of material surrounding an entirety of the perimeter.

13. The method of claim 10, further comprising:
enclosing one or more additional portions of the flexible frame with the one or more elastomeric material to produce one or more additional enclosed portions of the flexible frame; and
attaching the one or more additional enclosed portions to the mesh screen at or substantially proximate to one or more additional perimeter portions of the perimeter of the mesh screen so that an entirety of the perimeter is surrounded by the flexible frame having the at least a first enclosed portion and the one or more additional enclosed portions.

14. The method of claim 12, further comprising attaching an end from the at least a first enclosed portion or the one or more additional enclosed portions with a different end of the at least a first enclosed portion or the one or more additional enclosed portions.

15. The method of claim 10, wherein the enclosing and attaching comprise by sewing, adhering, buttoning, snapping, or combinations thereof.

16. The method of claim 11, wherein the flexible window screen is custom-sized or standard-sized.

17. A method comprising:
pushing a flexible window screen into at least a portion of a window seal of a window opening; and
retaining, by the window seal, at least a portion of the flexible window screen.

18. The method of claim 17, further comprising fully opening the window opening.

19. The method of claim 17, wherein the flexible window screen comprises:
a mesh screen having a perimeter;
one or more elastomeric materials;
a flexible frame that surrounds the one or more elastomeric materials at one or more portions of the flexible frame, wherein the flexible frame is attached to the mesh screen at or substantially proximate to the perimeter; and
optionally, one or more portions of material without the one or more elastomeric materials that form one or more other portions of the flexible frame also surrounded by the one or more elastomeric materials,
wherein the flexible frame surrounds at least a portion of an entirety of the perimeter.

20. The method of claim 17, further comprising hanging down of flexible window screen that is not in the window seal.
